(19) United States
(12) Patent Application Publication
(10) Pub. No.: US 2023/0189823 A1
(43) Pub. Date: Jun. 22, 2023

(54) Process for Preparing Pizza

(71) Applicant: Eric Brian Tuch, Lemoyne, PA (US)

(72) Inventor: Eric Brian Tuch, Lemoyne, PA (US)

(21) Appl. No.: 18/108,717

(22) Filed: Feb. 13, 2023

Related U.S. Application Data
(63) Continuation-in-part of application No. 16/905,800, filed on Jun. 18, 2020, now Pat. No. 11,576,388.
(60) Provisional application No. 62/863,350, filed on Jun. 19, 2019.

(51) Int. Cl. A21B 3/13; A21D 13/41

(52) U.S. Cl. CPC A21B 3/13; A21D 13/41

(57) ABSTRACT

A process for grilling pizza includes shaping pizza dough to a predetermined configuration to provide a flattened dough, placing the shaped dough on a design bearing grate, grilling one side of the shaped pizza dough on a design bearing grate to form a design in the pizza dough, applying condiments to the grilled side, and baking the partially cooked pizza.

### CROSS-REFERENCE TO RELATED APPLICATIONS

The present application is a continuation-in-part of pending U.S. patent application Ser. No. 16/905,800, filed Jun. 18, 2020, which claims the benefit of U.S. Provisional Patent Application 62/863,350, filed Jun. 19, 2019, which are incorporated herein in their entireties by reference.

### BACKGROUND OF THE INVENTION

### 1. Field of the Invention

The present invention relates to a process for preparing pizza.

### 2. Brief Summary of the Prior Art

Pizza, a highly popular food, is traditionally prepared by hand in a time-consuming process. Many improvements have been proposed over the years to this process, many of which have been directed to reducing the time required to prepare the food.

Conventionally, dough is formed by hand into a traditional round or rectangular shape, garnishes are applied to the surface of the dough, and the raw dough laden with the garnishes is baked in a traditional pizza oven.

Proposed improvements in the preparation process are legion. For example, U.S. Pat. No. 4,378,729 discloses a method and apparatus for uniformly heating a fresh or frozen pizza. U.S. Pat. No. 4,701,340 discloses an oven for preparing pizza including three chambers and a conveyor for transporting pizza through the oven to reduce cooking time. U.S. Pat. No. 5,200,225 discloses a machine and process for quickly baking pizza using super-heated steam. U.S. Pat. No. 5,997,924 purports to automate the entire process with a self-service vending machine robotically adding user-selected garnishes to pre-made pizza crust, baking the pizza, and dispensing the result into a cardboard box. U.S. Pat. No. 6,843,167 provides a mass production technique for par-baking pizza crusts from dough and subsequently distributing frozen par-baked crusts to pizza shops for final assembly of the pies.

While many different pizza preparation techniques have been proposed, the ultimate product obtained is measured against the standard of pies produced by traditional techniques, with nothing other than taste and texture to signal the process used to prepare a superior pizza. Despite the extensive efforts to improve the pizza preparation process, there is a continuing need for a process which rapidly provides a unique pizza product which itself signals to the consumer the technique employed to prepare the product.

### SUMMARY OF THE INVENTION

The present invention provides an improved process for preparing a pizza. The process comprises providing pizza dough and shaping the pizza dough to a predetermined configuration to provide a flattened, shaped dough having a first side and a second side. The process also includes providing a first carrier device which has a bearing surface for contacting the pizza dough. The process further comprises placing the shaped dough on the first carrier device with the first side of the shaped dough facing the bearing surface of the first carrier device. The process further comprises grilling the shaped dough on the first carrier device to provide a pizza crust having a first side and a second side, such that the pizza crust becomes partially cooked on a first side of the pizza crust. The process further comprises providing a second carrier device having a bearing surface, and placing the second side of the partially cooked pizza crust on the bearing surface of the second carrier device, The process also comprises placing at least one additional ingredient on the first side of the partially cooked pizza crust to provide a partially cooked pizza, and baking the partially cooked pizza to provide a fully cooked pizza.

Preferably, the process further comprises placing the partially cooked pizza, resting on the second carrier device, in an oven for baking the partially cooked pizza.

Preferably, the oven includes an entrance opening and an exit opening, and a conveyor for conveying the partially cooked pizza from the entrance opening to the exit opening. The process further comprises conveying the partially cooked pizza from the entrance opening to the exit opening of the oven.

Preferably, the process further includes engaging the second carrier device with the conveyor to transport the partially cooked pizza from the entrance opening to the exit opening.

Preferably, the process further comprises providing an open flame in the oven to bake the partially cooked pizza.

Preferably, the process further comprises providing a refractory lining within the oven to retain heat within the oven.

Preferably, the process further comprises providing an assembly station for receiving the partially cooked pizza crust.

Preferably, the process further comprises placing the partially cooked pizza crust in the assembly station.

Preferably, the process further comprises providing a sauce receptacle in the assembly station.

Preferably, the process further comprises placing sauce in the sauce receptacle and applying sauce from the sauce receptacle on the partially cooked pizza crust.

Preferably, the process further comprises providing a plurality of garnish receptacles in the assembly station.

Preferably, the process further comprises placing garnishes in at least some of the garnish receptacles, and applying at least one garnish, such as tomato sauce on the partially cooked pizza crust.

Preferably, the process further comprises providing a decorative design on the bearing surface of the first carrier device.

Preferably, the process further comprises grilling the shaped dough on the first carrier device to provide a decorative design on the first side of the pizza crust.

Preferably, the process further comprises providing a first grate as the bearing surface on the first carrier device for suspending the pizza dough on the first carrier device.

Preferably, the process further comprises providing a second grate as the bearing surface on the second carrier device for suspending the partially cooked pizza crust in the oven.

In one aspect of the process of the present invention, the predetermined configuration of the dough is round, and in another aspect, the predetermined configuration of the dough is rectangular.

Preferably, wherein the assembly station includes a heating mechanism for the sauce receptacle, and further comprising heating the sauce receptacle.

In another aspect, the present invention provides a process for preparing a pizza, in which aspect the process includes providing pizza dough and shaping the pizza dough to a predetermined configuration to provide a flattened shaped dough having a first side and a second side. In this aspect, the present invention further includes providing a carrier device, the carrier device having a bearing surface for contacting the pizza dough and placing the shaped dough on the carrier device, with the first side of the shaped dough facing the bearing surface of the carrier device. In this aspect of the present invention, the bearing surface of the carrier device is provided with a three-dimensional decorative design.

In this aspect, the present invention further comprises grilling the shaped dough on the carrier device to provide a pizza crust having a first side and a second side, the pizza crust becoming partially cooked on the first side of the pizza crust. In this aspect of the present invention, grilling the shaped dough on the carrier device provides a decorative design on the first side of the pizza crust. In this aspect, the present invention further includes further cooking the pizza crust to provide a fully cooked pizza.

In yet another aspect, the present invention provides apparatus for preparing pizza. In this aspect, the present invention provides a grate for grilling pizza dough. The grate includes a bearing surface having a plurality of openings. The bearing surface includes a generally flat central surface, and a rim extending from the central surface. The rim extends at an angle from the plane of the central surface. The grate also includes a base extending from the bearing surface for supporting the bearing surface in a horizontal orientation, and for positioning the bearing surface above the surface of a grill such that the rim of the bearing surface does not contact the grill. Preferably, the rim extends at an angle of from about 15 degrees to 85 degrees, more preferably from about 30 degrees to 60 degrees, and still more preferably about 45 degrees.

In another aspect, the present invention provides a grate for grilling pizza dough, the grate includes a bearing surface for receiving pizza dough, and having a plurality of openings. The bearing surface includes a generally flat central surface, and a rim extending from the central surface. The rim extends, preferably downward, at an angle from the plane of the central surface.

Preferably, the grate also includes a base extending from the bearing surface for supporting the bearing surface in a horizontal orientation, and for positioning the bearing surface above the surface of a grill such that the rim of the bearing surface does not contact the grill. Preferably, the grate further includes at least one decorative device. The at least one decorative device is preferably releasably attached to the rim.

Preferably, the rim comprises a pair of concentric, axially spaced, preferably circular, rings, and the at least one decorative device is attached to each of the pair of rings. Preferably, the at least one decorative device includes an attachment device. Preferably, the attachment device comprises a C-shaped clip.

### BRIEF DESCRIPTION OF THE FIGURES

FIG. 1 is a schematic representation of an embodiment of the process of the present invention.

FIG. 2 is a perspective view of an apparatus for preparing pizza according to the present invention.

FIG. 3 is a perspective view of a first carrier device for use in the process of the present invention.

FIG. 4 is a perspective view of an oven for use in the process of the present invention.

FIG. 5 is a side elevational view of the oven of FIG. 4.

FIG. 6 is a sectional elevational view taken along the line A-A of FIG. 5.

FIG. 7 is a fragmentary enlarged perspective view of the detail B of FIG. 5.

FIG. 8 is a top plan view of the first carrier device of FIG. 3.

FIG. 9 is a front elevational view of the first carrier device of FIG. 3.

FIG. 10 is a side elevational view of the first carrier device of FIG. 3.

FIG. 11 is a bottom plan view of the first carrier device of FIG. 3.

FIG. 12 is a fragmentary side elevational view of the rim of a grate according to the present invention.

FIG. 13 is a fragmentary perspective view of the rim of a grate according to FIG. 12 as seen from the interior.

### DETAILED DESCRIPTION

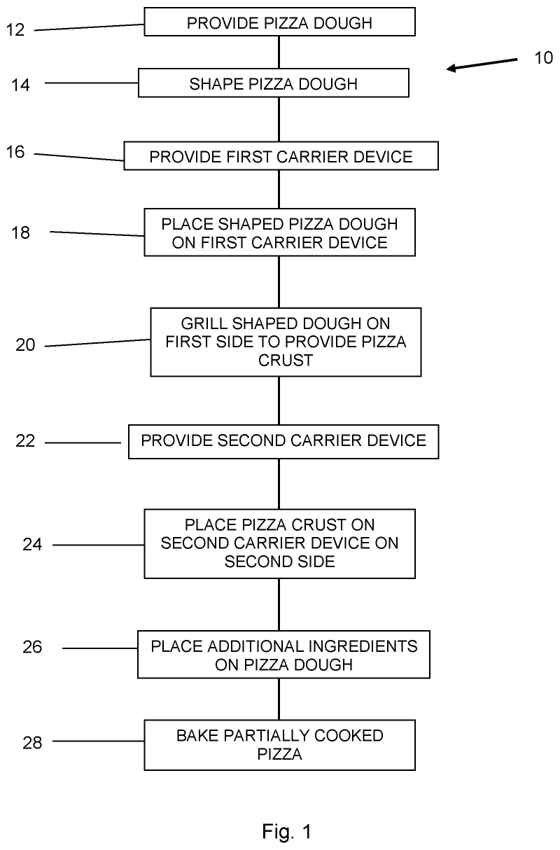

Referring now to the figures in which like reference numerals represent like elements in each of the several views, there is shown in FIG. 1 a schematic representation of a presently preferred embodiment 10 of the process of the present invention. In this embodiment, the process first includes providing 12 pizza dough as by preparing the dough from raw ingredients and thawing frozen dough obtained from an off-site source, or the like.

The dough is then shaped 14 to a predetermined configuration, such as a circular, rectangular or square shape, to provide a flattened shaped dough having a first side and a second side. Traditional methods for shaping pizza dough can be employed.

The process further includes providing 16 a first carrier device 140, such as depicted in the perspective view of FIG. 3. The first carrier device 140 has a bearing surface or surface 142 for contacting the pizza dough. The shaped dough is placed 18 on the first carrier device 140 with the first side of the shaped dough facing the bearing surface 142 of the first carrier device 140. Next, the shaped dough is grilled 20 on the first carrier device to provide a pizza crust having a first side and a second side. Thus, the pizza crust becoming partially cooked on a first side of the pizza crust.

Next, a second carrier device 170 having a bearing surface 172 is provided 22, and the second side of the partially cooked pizza crust is placed 24 on the bearing surface 172 of the second carrier device 170. That is, the partially cooked pizza crust is flipped over such that the grilled, partially cooked side of the pizza crust is on top. Next, additional ingredients are placed 26 on the first side of the partially cooked pizza crust to provide a partially cooked pizza. Ingredients can include grated cheese such as mozzarella, tomato sauce, cooked or raw onions, meats such as sausage and pepperoni, anchovies, and the like. Finally, the partially cooked pizza is baked 28 to provide a fully cooked pizza.

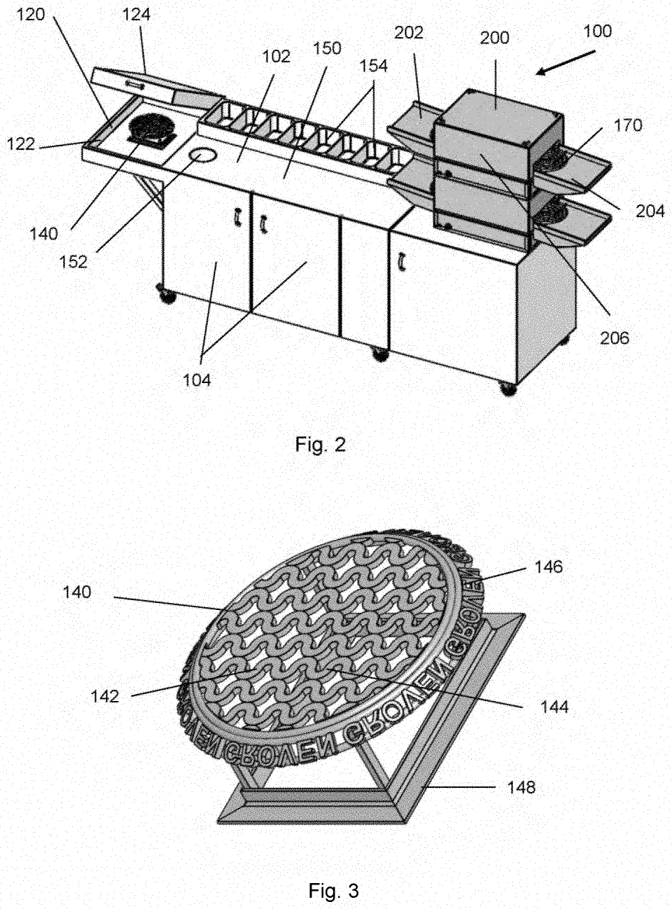

An apparatus 100 for carrying out the process of the present invention is depicted in the perspective view of FIG. 2. The apparatus 100 includes a working surface 102 atop a plurality of storage cabinets 104 for supplies. One end of the pizza preparation apparatus 100 is provided with a grill station 120 including a grill 122 optionally provided with a heat-retaining cover 124.

In operation, a first carrier device 140 carrying a suitably shaped piece of pizza dough is placed on top of the grill 122 in the grill station 120, and the dough is grilled to provide a partially cooked pizza crust. The partially cooked pizza crust is then inverted and transferred to the second carrier device 170 such that the grilled side of the partially cooked pizza crust faces upward.

The second carrier device 170 is positioned in an assembly station 150 which includes a portion of the working surface 102, as well as sauce receptacle 152, which is optionally heated with a suitable heating mechanism 156 (not shown) such as an electrical resistance heater, and a plurality of garnish receptacles 154, which are optionally refrigerated, filled with suitable pizza toppings or garnishes such as grated cheese, onions, mushrooms, anchovies, sweet peppers, hot peppers, ground sausage, sliced pepperoni, and the like. Additional ingredients selected from among the garnish receptacles 154 are arranged or placed 26 on the partially cooked pizza crust as desired. The partially cooked pizza crust, adorned with the additional ingredients is then placed in a baking station or oven 200 at a second end of the apparatus 100, and baked 28 to provide a fully cooked pizza.

In a presently preferred embodiment, the apparatus 100 is provided with a plurality of stackable ovens 200 permitting multiple pizzas to be baked simultaneously.

As shown in the perspective view of FIG. 3, the first carrier device 140 includes a first bearing surface or grate 142 provided with an ornamental design, as well as a supporting stand 148 for spacing the bearing surface 142 carrying the pizza dough from the surface of the grill 122.

During the grilling process, the design formed by the bearing surface 142 is at least partially transferred to the surface of the pizza dough contacting the bearing surface 142 of the first carrier device 140, The design can be strictly ornamental, or may optionally include information identifying the source of the pizza, such as the name or logo of a restaurant or “fast food” chain providing the pizza. The first bearing surface 142 includes a generally flat central portion 144 which is at least partially bounded at the outward edge of the central portion 144 by a generally downwardly projecting rim 146. Preferably, the pizza dough is sized and shaped such that when the pizza dough is applied to the bearing surface 142, the pizza dough extends over the edge of the flat central portion 144 and drapes over the rim 146.

When the partially cooked pizza dough is inverted after grilling on the first carrier device 140, the portion of the partially cooked pizza dough that draped over the rim 146, that is the edge of the pizza dough, now stands up at an angle from the a generally flat central portion of the partially cooked pizza dough. Indicia that has been seared onto the edge of the pizza dough can remain visible even after the central portion of the partially cooked pizza dough has been covered with garnishes and the partially cooked pizza dough has been baked in the oven, thus providing an opportunity for branding.

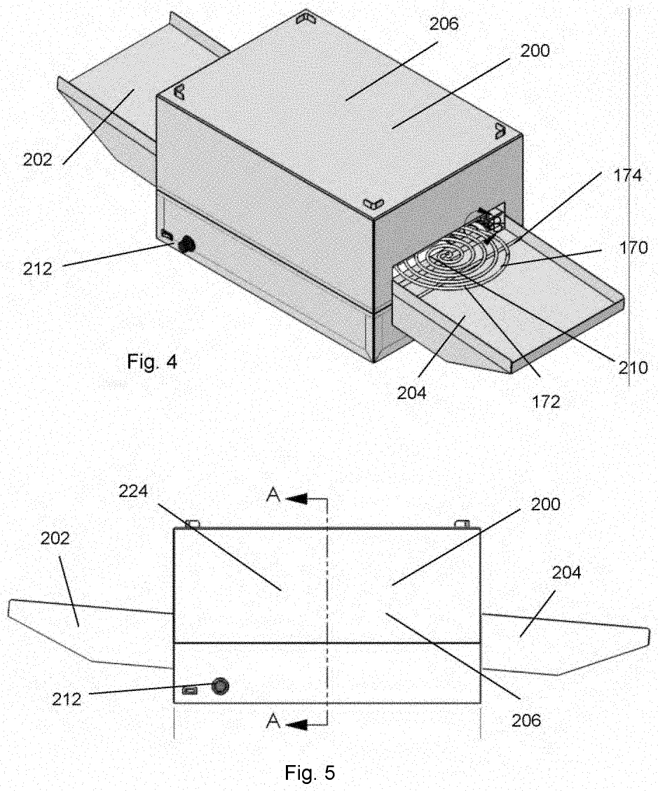

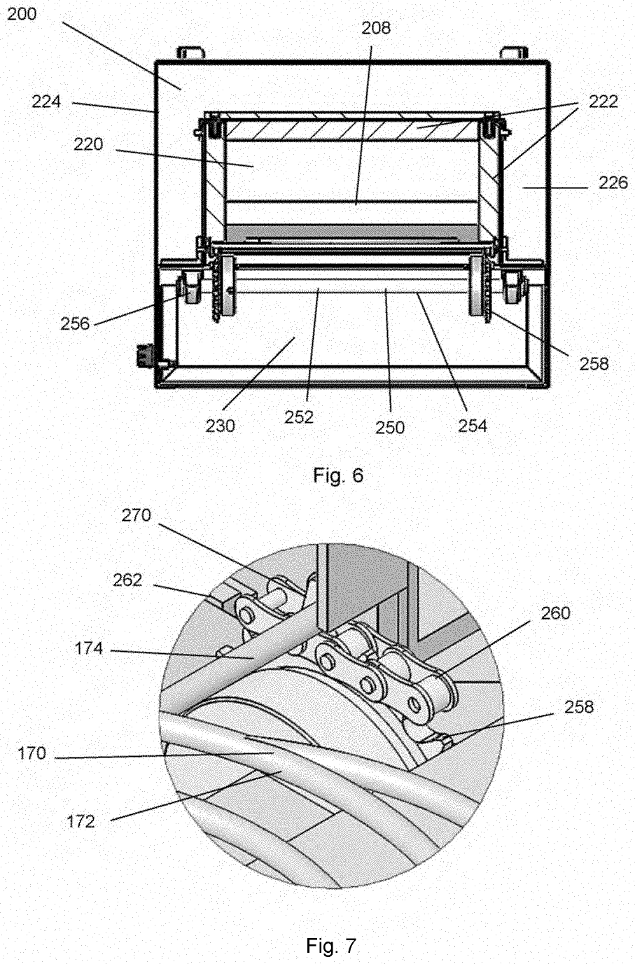

As shown in the perspective view of FIG. 4, the oven 200 includes an entrance ramp 202 and an exit ramp 204 arranged on either side of a central portion 206 provided with an entrance opening 208 (FIG. 6) to permit a second carrier device 170 bearing a partially cooked pizza to enter the central portion 206, and an exit opening 210 to permit a second carrier device 170 bearing a corresponding fully cooked pizza to leave the central portion 206.

As best seen in the side elevational view of FIG. 5, the entrance ramp 202 and the exit ramp 204 are each slightly inclined from the horizontal to assist respectively in feeding a second carrier device 170 into the central portion 206 of the oven 200 through the entrance opening 208 and removing a second carrier device 170 from the central portion 206 of the oven 200 through the exit opening 210.

As shown in the sectional elevational view of FIG. 6, taken along the line A-A of FIG. 5, the central portion 206 of the oven 200 includes a cooking chamber 220 lined with heat-retaining refractory material 222 such as a heat-retaining ceramic enclosed within an outer sheet metal case 224 preferably formed from stainless steel or a similar material. The cooking chamber is preferably enclosed at least on the bottom and sides with an integral inner shell. An insulative space 226 extends between the outer case 224 and the inner shell and heat-retaining refractory material, the insulative space 226 being optionally filled with an insulative material.

A service chamber 230 is provided in the central portion 206 of the oven 200 beneath the cooking chamber 220. The service chamber 230 is provided with suitable heat-providing elements such as one or more gas burners (not shown) to provide an open flame, or the like. In addition, the service chamber is provided with an electric motor, suitable wiring for controlling the motor, and plumbing for providing gas to the burners, etc. (not shown).

A conveyor or transport mechanism 250 is provided between the cooking chamber 220 and the service chamber 230 for moving a second carrier device 170 from the entrance opening 208 to the exit opening 210 of the oven 200. The transport mechanism 250 includes a plurality of transport units 252 each including a central axle 254 mounted on a pair of bearings 256 at either end of the axle 254. Each transport unit 252 includes a toothed wheel or gear 258 mounted proximate either end of the central axle 254 for engaging a pair of chains 260.

In a presently preferred embodiment, a first transport unit 252 is mounted proximate the entrance 208 (FIG. 6) to the oven 200 and a second transport unit 252 is mounted proximate the exit 210 of the oven 200 (not shown). At least one of the chains 260 is driven by a suitable electric motor through a suitable drive train (not shown). The chains 260 are supported by guide bars 262 extending between the first and second transport units 252 and each of the chains 260 is provided with a plurality of upstanding cogs 270, as can be seen in the enlarged fragmentary detailed perspective view of FIG. 7, for engaging a second carrier device 170 to transport the second carrier device 170 from the entrance 208 of the oven 200 to the exit 210 of the oven 200. The heat applied to the oven 200 and the rate of transport through the oven 200 are adapted to provide fully cooked pizza and are variable with suitable controls 212 (FIG. 4).

Preferably, the second carrier device 170 is formed from stainless steel rod or some similar material into a shape which permits good heat transfer to the bottom of the partially cooked pizza as it is transported through the oven 200 and which fully supports the partially cooked pizza. Thus, in the case of a round partially cooked pizza, the stainless steel rod may be formed into a spiral shape as shown in FIG. 4 to form a bearing surface 172. The second carrier device 170 may also include a pair of spaced parallel stainless steel support rods 174 welded to the underside of the spiral bearing surface 172 and extending from either side of the spiral bearing surface 172 for engaging the upstanding cogs 270 of the chains 260 of the conveyor 250.

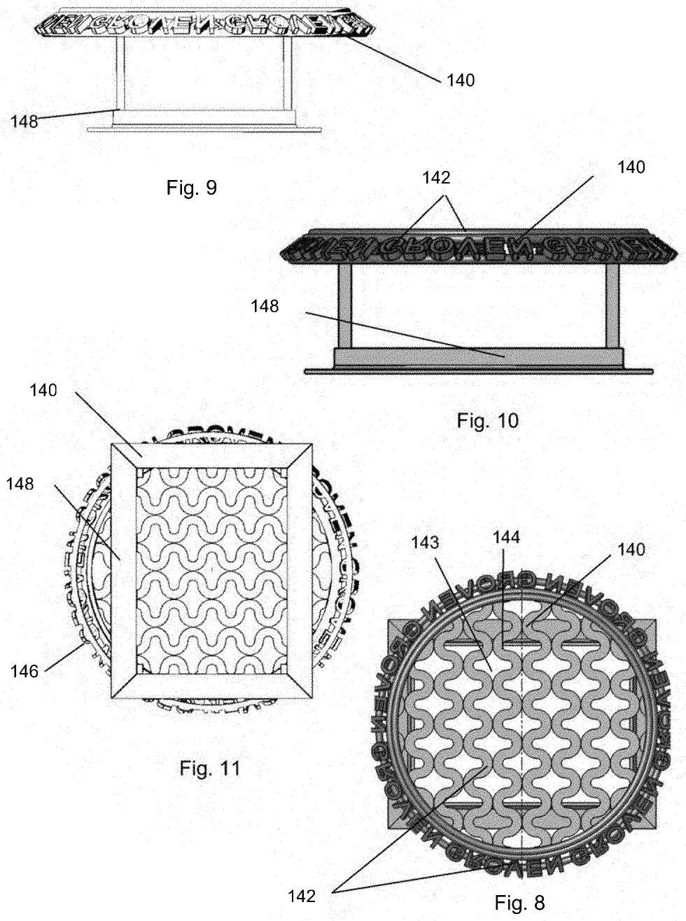

As best seen in the plan and elevational views of FIGS. 8-11, the first carrier device 140 includes a bearing surface or grate 142 having a plurality of openings 143. The bearing surface 142 includes a generally flat central surface portion 144, and a rim 146 extending from the central surface portion 144. The rim 146 extends at an angle from the plane of the central surface portion 144. The carrier device 140 also includes a base or stand 148 extending from the bearing surface 142 for supporting the bearing surface 142 in a horizontal orientation, and for positioning the bearing surface 142 above the surface of the grill such that the rim 146 of the bearing surface 142 does not contact the grill. Preferably, the rim 146 extends at an angle of from about 15 degrees to 85 degrees, more preferably from about 30 degrees to 60 degrees, and still more preferably about 45 degrees. Preferably, the openings 143 are arranged in an ornamental design, form text to convey information, or are arranged in an ornamental design which includes text.

When raw pizza dough is placed on the carrier device 142, the portions of the dough adjacent the openings 143 in the bearing surface 142 cook at a different rate than those portions of the dough surface actually in contact with the surface of the bearing surface 142, permitting a pattern corresponding to the pattern of the openings in the bearing surface to be seared onto the surface of the pizza dough.

In a presently preferred embodiment, the present invention provides a carrier device 140 for grilling pizza dough. The carrier device 140 includes a bearing surface or grate 142 for receiving pizza dough. The bearing surface 142 preferably has a plurality of openings 143. The bearing surface 142 includes a generally flat central surface 144, and a rim 146 extending from the central surface, preferably at an angle from the plane of the central surface. Preferably, the rim 146 forms a decorative border around the generally flat central surface 144.

The carrier device 140 also preferably includes a base extending from the bearing surface for supporting the bearing surface in a horizontal orientation, and for positioning the bearing surface above the surface of a grill such that the rim of the bearing surface does not contact the grill.

Preferably, as best seen in the partial, fragmentary perspective view of FIG. 13, the grate 142 also includes at least one decorative device 290, which is preferably releasably attached to the rim 146. The decorative device 290 can be, for example, a letter of the alphabet, an abstract design, or the like. A collection of decorative devices 290 can be provided, such that an individualized message can be formed by positioning the selected decorative devices, and that message to be subsequently seared into the pizza crust. The decorative device 290 includes an attachment device 292 such as a C-shaped metal spring clip 292 bonded to the body of the decorative device 290 such as by welding.

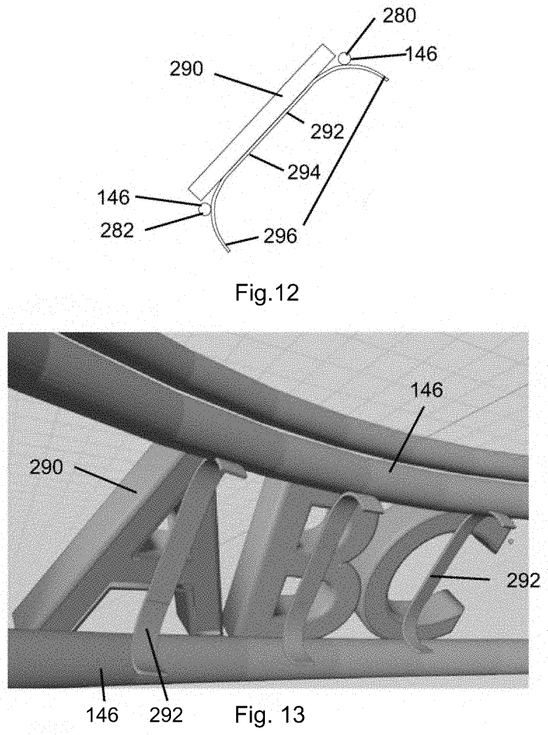

As best seen in the fragmentary elevational sectional view of FIG. 12, the attachment device 292 includes a generally flat central portion 294 and a pair of curved ends 296 and 298 extending away from the body of the decorative device 290. The attachment device 292 is sufficiently flexible such that the curved ends 296 and 298 can be pushed towards one another, and the decorative device can be inserted between the rings 280, 282 of the rim 146 and then released to secure the decorative device 290 in place on the rim 146.

Various modifications can be made in the details of the various embodiments of the process and apparatus of the present invention, all within the scope and spirit of the invention as defined by the appended claims

1. A grate for grilling pizza dough, the grate including:
a bearing surface for receiving pizza dough, and having a plurality of openings, the bearing surface including a generally flat central surface, and a rim extending from the central surface, the rim extending at an angle from the plane of the central surface.

2. The grate according to claim 1 further comprising at least one decorative device, the at least one decorative device being releasably attached to the rim.

3. The grate according to claim 2 wherein the rim comprises a pair of concentric, axially spaced rings, and the at least one decorative device is attached to each of the pair of rings.

4. The grate according to claim 2 wherein the at least one decorative device includes an attachment device.

5. The grate according to claim 4 wherein the attachment device comprises C-shaped clips.

6. The grate according to claim 3 wherein the rings are circular.

7. A grate for grilling pizza dough, the grate including:
a bearing surface for receiving pizza dough, and having a plurality of openings, the bearing surface including a generally flat central surface, and a rim extending from the central surface, the rim extending at an angle from the plane of the central surface,
a base extending from the bearing surface for supporting the bearing surface in a horizontal orientation, and for positioning the bearing surface above the surface of a grill such that the rim of the bearing surface does not contact the grill, and
at least one decorative device, the at least one decorative device being releasably attached to the rim.

8. The grate according to claim 7 wherein the rim comprises a pair of concentric, axially spaced rings.

9. The grate according to claim 8 wherein the at least one decorative device is attached to each of the pair of rings.

10. The grate according to claim 7 wherein the at least one decorative device includes an attachment device.

11. The grate according to claim 10 wherein the attachment device comprises C-shaped clips.

12. A grate for grilling pizza dough, the grate including:
a bearing surface for receiving pizza dough, the bearing surface having a plurality of openings, the bearing surface including a generally flat central surface, and a rim extending from the central surface, the rim extending at an angle from the plane of the central surface, and
a base extending from the bearing surface for supporting the bearing surface in a horizontal orientation, and for positioning the bearing surface above the surface of a grill such that the rim of the bearing surface does not contact the grill.

13. The grate according to claim 12 further comprising at least one decorative device, the at least one decorative device being releasably attached to the rim.

14. The grate according to claim 13 wherein the rim comprises a pair of concentric, axially spaced rings, and the at least one decorative device is attached to each of the pair of rings.

15. The grate according to claim 13 wherein the at least one decorative device includes an attachment device.

16. The grate according to claim 15 wherein the attachment device comprises C-shaped clips.

17. The grate according to claim 14 wherein the rings are circular.
